(19) United States
(12) Patent Application Publication
(10) Pub. No.: US 2026/0302100 A1
(43) Pub. Date: Oct. 1, 2026

(54) PUSH SWITCH

(71) Applicant: Alps Alpine Co., Ltd., Tokyo (JP)

(72) Inventor: Hiroshi OHARA, Miyagi-ken (JP)

(21) Appl. No.: 19/549,541

(22) Filed: Feb. 25, 2026

(30) Foreign Application Priority Data
Mar. 28, 2025 (JP) 2025-056094

(51) Int. Cl. H01H 13/14; H01H 13/20

(52) U.S. Cl. CPC H01H 13/14; H01H 13/20

(57) ABSTRACT

A push switch includes a case including an accommodation portion, a central fixed contact provided at a center portion of a bottom of the accommodation portion, a movable contact member disposed inside the accommodation portion, the movable contact member having a central movable contact capable of being releasably connected to the central fixed contact, and a metal leaf spring member disposed above the movable contact member in the accommodation portion, the metal leaf spring member pressing the central movable contact when subjected to a pressing force from above and generating an operation sensation, wherein the movable contact member has a tongue portion extending in a direction away from the central movable contact, and when the central movable contact is pressed by the leaf spring member, the central movable contact moves downward while the tongue portion is elastically deformed, causing the central movable contact to contact the central fixed contact.

### CLAIM OF PRIORITY

This application claims benefit of Japanese Patent Application No. 2025-056094 filed on Mar. 28, 2025, which is hereby incorporated by reference.

### BACKGROUND OF THE INVENTION

### 1. Field of the Invention

The present invention relates to a push switch.

### 2. Description of the Related Art

Japanese Unexamined Patent Application Publication No. 2024-64523 discloses a push switch configured so that, when a pressing operation is performed, a metal dome performs an inversion motion to press a movable contact, thereby bringing the movable contact into contact with a central fixed contact.

However, in a case where the push switch in the related art is configured so that the first switch-on state in which the movable contact and the peripheral fixed contact are electrically connected with each other at the time of the non-pressing operation occurs, and the second switch-on state in which the movable contact and the central fixed contact are electrically connected with each other at the time of the pressing operation occurs, it is difficult to shorten the switching time between the first switch-on state and the second switch-on state.

### SUMMARY OF THE INVENTION

A push switch according to an embodiment includes a case including an accommodation portion, a central fixed contact provided at a center portion of a bottom of the accommodation portion, a movable contact member disposed inside the accommodation portion, the movable contact member having a central movable contact capable of being releasably connected to the central fixed contact, and a metal leaf spring member disposed above the movable contact member in the accommodation portion, the metal leaf spring member pressing the central movable contact when subjected to a pressing force from above and generating an operation sensation, wherein the movable contact member has a tongue portion extending in a direction away from the central movable contact, and when the central movable contact is pressed by the leaf spring member, the central movable contact moves downward while the tongue portion is elastically deformed, causing the central movable contact to contact the central fixed contact.

With a push switch according to an embodiment, the switching time of the contact state between the first switch-on state and the second switch-on state can be shortened.

### BRIEF DESCRIPTION OF THE DRAWINGS

FIG. 1 is an appearance perspective view of a push switch according to an embodiment;

FIG. 2 is an exploded perspective view of the push switch according to an embodiment;

FIG. 3 is a cross-sectional view of the push switch according to an embodiment;

FIG. 4 is an appearance perspective view of the case of the push switch according to an embodiment;

FIG. 5 is an appearance perspective view of the case (with a movable contact member disposed) of the push switch according to an embodiment;

FIG. 6 is an appearance perspective view of the case (with the movable contact member and the leaf spring member disposed) of the push switch according to an embodiment;

FIG. 7 is a cross-sectional view showing the state of the push switch at the time of the non-pressing operation according to an embodiment;

FIG. 8 is a cross-sectional view showing the state of the push switch at the time of the pressing operation according to an embodiment; and

FIG. 9 is a cross-sectional view showing the pressing configuration with the protrusion of the rubber stem in the push switch according to an embodiment.

### DESCRIPTION OF THE PREFERRED EMBODIMENTS

Hereinafter, an embodiment will be described with reference to the drawings. In the following description, for convenience, the Z axis direction in the figure is the vertical direction, the Y axis direction in the figure is the left-right direction, and the X axis direction in the figure is the front-back direction. The Z axis positive direction is the upward direction, the Y axis positive direction is the right direction, and the X axis positive direction is the forward direction.

### Overview Of Push Switch 100

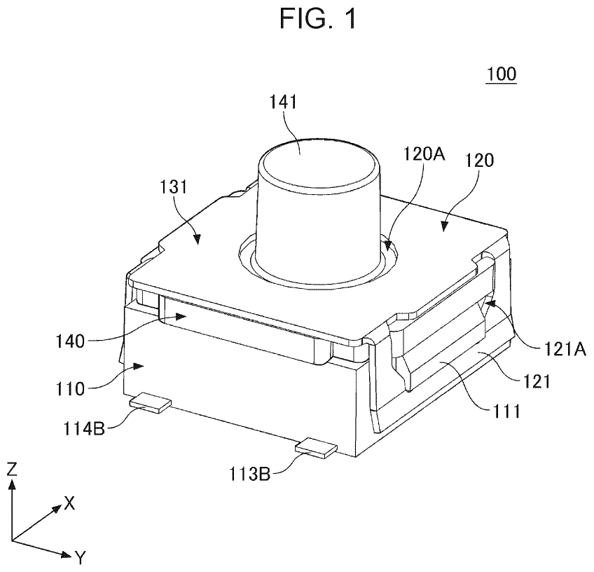

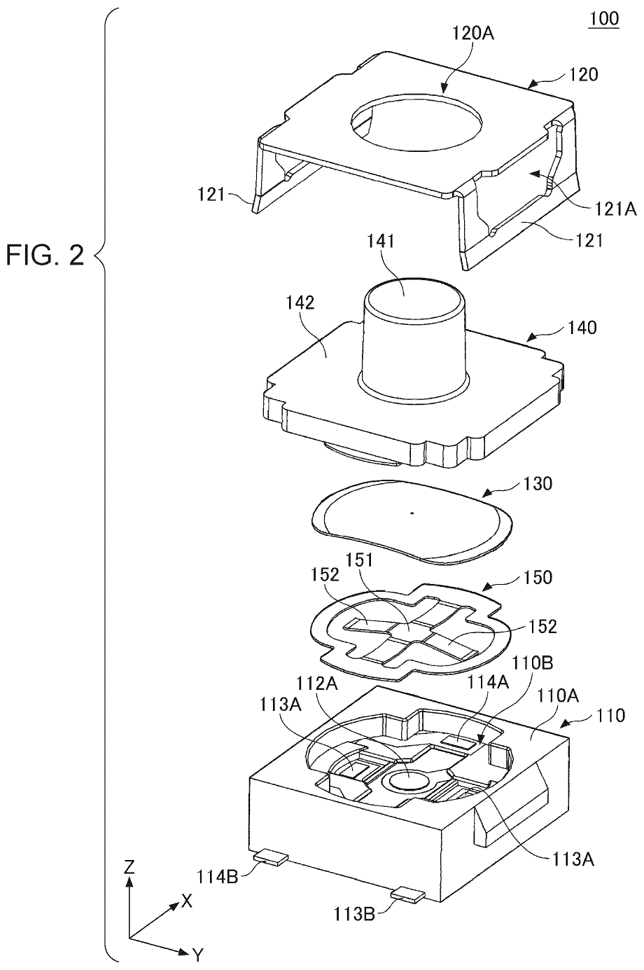

FIG. 1 is an appearance perspective view of a push switch 100 according to an embodiment. As shown in FIG. 1, the push switch 100 is configured so that a rubber stem 140 is superimposed on an upper face 110A (see FIG. 2) of a case 110, and the rubber stem 140 is covered by a cover member 120. A cylindrical operation portion 141 protruding upward (Z axis positive direction) is provided at the center portion of the rubber stem 140.

The operation portion 141 of the rubber stem 140 passes through a circular opening 120A formed at the center portion of the cover member 120 and protrudes upward (Z axis positive direction) beyond the cover member 120. This allows the push switch 100 to be operated by the operator pressing the operation portion 141 of the rubber stem 140 downward (Z axis negative direction), and the pressing operation enables switching from the first switch-on state to the second switch-on state.

### Configuration of Push Switch 100

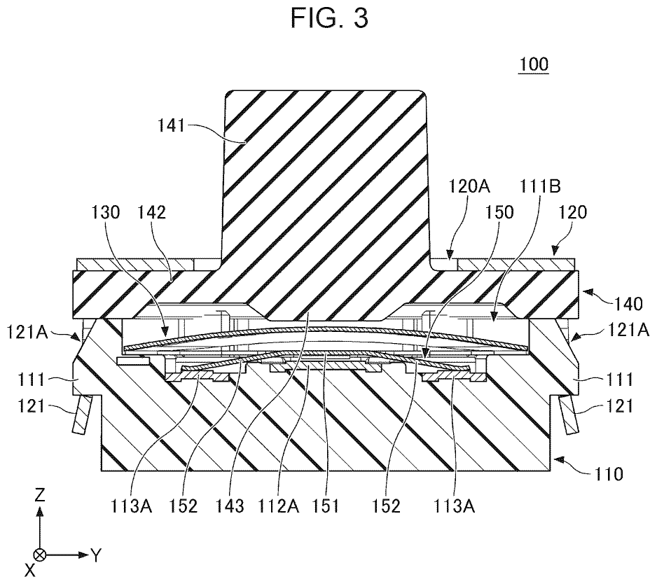

FIG. 2 is an exploded perspective view of the push switch 100 according to an embodiment. FIG. 3 is a cross-sectional view of the push switch 100 according to an embodiment. As shown in FIGS. 2 and 3, the push switch 100 includes the case 110, a movable contact member 150, a leaf spring member 130, the rubber stem 140, and the cover member 120.

The case 110 is a container-like member having a thin rectangular prism shape in the vertical direction (Z axis direction). The case 110 has a generally square shape when viewed from above. The case 110 has an accommodation portion 110B recessed downward from the upper face 110A. The accommodation portion 110B accommodates the leaf spring member 130 and the movable contact member 150 therein. For example, the case 110 is formed by insert molding using a relatively hard insulating material (for example, hard resin, etc.).

The case 110 has a claw 111 at each of the pair of left-right side faces, the claw protruding outward. When the cover member 120 is mounted on the upper face 110A of the case 110, the claw 111 can hook a hook 121 by being fit into an opening 121A of the hook 121 of the cover member 120 to fix the cover member 120 to the case 110 (see FIG. 1).

The bottom of the accommodation portion 110B of the case 110 is provided with a central fixed contact 112A, a pair of peripheral fixed contacts 113A, and a pair of common contacts 114A.

The central fixed contact 112A is provided at the center portion of the bottom of the accommodation portion 110B and is provided facing a central movable contact 151 of the movable contact member 150.

The pair of peripheral fixed contacts 113A is provided around the central fixed contact 112A at the bottom of the accommodation portion 110B, and is provided away from the central fixed contact 112A in the left-right direction (Y axis direction). The peripheral movable contact 152A of the movable contact member 150 is placed on each of the pair of peripheral fixed contacts 113A.

The pair of common contacts 114A is provided around the central fixed contact 112A on the inner bottom face of the accommodation portion 110B, and is away from the central fixed contact 112A in the front-back direction (X axis direction). The outer frame portion 153 of the movable contact member 150 is placed on each of the pair of common contacts 114A.

The central fixed contact 112A is integrally formed with a central fixed contact member 112. Furthermore, the pair of peripheral fixed contacts 113A is integrally formed with the single peripheral fixed contact member 113. Furthermore, the pair of common contacts 114A is integrally formed with the single common contact member 114. The central fixed contact member 112, the peripheral fixed contact member 113, and the common contact member 114 are formed using a conductive metal plate and are embedded into the case 110 by insert molding.

The central fixed contact member 112 has an external connection terminal 112B (not shown) that protrudes from the front (X axis positive side) side face of the case 110. The peripheral fixed contact member 113 has an external connection terminal 113B that protrudes from the rear (X axis negative side) side face of the case 110. The common contact member 114 has two external connection terminals 114B that protrude from the front (X axis positive side) side face and the rear (X axis negative side) side face of the case 110.

The leaf spring member 130 is disposed above the movable contact member 150 (Z axis positive side) inside the accommodation portion 110B of the case 110. The leaf spring member 130 is a dome-shaped member made of a thin metal plate, having a central top in plan view from above (Z axis positive direction). The leaf spring member 130 has an elliptical shape with the left-right direction (Y axis direction) in plan view from above (Z axis positive direction) as a longitudinal direction.

The leaf spring member 130 is a so-called “inversion spring”, and when the pressing operation on the operation portion 141 of the rubber stem 140 is performed, the top (central portion) is pushed downward by a pressing portion 143 of the rubber stem 140, and upon exceeding a predetermined operating load, the top undergoes a sudden elastic deformation into a recessed shape (inversion motion). This allows the leaf spring member 130 to press the central movable contact 151 of the movable contact member 150 at the underside of the top (central portion) section, thereby bringing the central movable contact 151 into contact with the central fixed contact 112A. At this point, the top undergoes a sudden elastic deformation into a recessed shape (inversion motion), so that the leaf spring member 130 can provide the operator with an operation sensation (click operation feel). Furthermore, the leaf spring member 130 returns to its original convex shape by an elastic force when the pressing operation on the operation portion 141 of the rubber stem 140 is cancelled.

The movable contact member 150 is a flat, metal member disposed on the bottom of the accommodation portion 110B of the case 110. The movable contact member 150 has the central movable contact 151 and a pair of tongue portions 152.

The central movable contact 151 is provided at the center portion of the movable contact member 150 and is capable of being releasably connected to the central fixed contact 112A provided at the bottom of the accommodation portion 110B of the case 110.

The pair of tongue portions 152 is tongue-shaped portions extending from the central movable contact 151 in the left-right direction (Y axis direction) and diagonally downward. In plan view from above (Z axis positive direction), each of the pair of tongue portions 152 has a strip-like portion extending linearly in the left-right direction (Y axis direction) with a constant width. Each of the pair of tongue portions 152 has a peripheral movable contact 152A at the distal end portion thereof. The pair of peripheral movable contacts 152A is capable of being releasably connected to the pair of peripheral fixed contacts 113A provided at the bottom of the accommodation portion 110B of the case 110.

The rubber stem 140 is a member that is pressed downward by the operator. The rubber stem 140 is placed on the upper face 110A of the case 110 and is fixed by the cover member 120 in a state closing the accommodation portion 110B of the case 110. The rubber stem 140 is made of an elastic material (for example, rubber, silicone, etc.). The rubber stem 140 includes the operation portion 141, a base portion 142, and the pressing portion 143.

The base portion 142 is a flat plate-like portion. The base portion 142 is integrally formed with the operation portion 141 and the pressing portion 143, and vertically movably supports the operation portion 141 and the pressing portion 143. Specifically, the rubber stem 140 allows the operation portion 141 and the pressing portion 143 to move vertically by the elastic deformation of the base portion 142. When viewed from above, the outer shape of the base portion 142 is substantially the same as the outer shape of the case 110 (that is, generally square shape). The rubber stem 140 is fixed to the upper face 110A of the case 110 by having the base portion 142 pressed down from above by the cover member 120.

The operation portion 141 is provided at the center portion of the upper face of the base portion 142 and has a cylindrical shape protruding upward (Z axis positive direction) from the base portion 142. The operation portion 141 passes through the opening 120A of the cover member 120 and is pressed by the operator.

The pressing portion 143 is provided at the center portion of the lower face of the base portion 142 and has a cylindrical shape protruding downward (Z axis negative direction) from the base portion 142. When the operator performs the pressing operation on the operation portion 141, the pressing portion 143 moves downward (Z axis negative direction) together with the operation portion 141, thereby pressing the top of the leaf spring member 130.

The cover member 120 is a flat, metal member. The cover member 120 has a generally square shape when viewed from above. The cover member 120 is fixedly mounted to the upper face 110A of the case 110 with the base portion 142 of the rubber stem 140 interposed therebetween, so that the cover member 120 covers both the base portion 142 of the rubber stem 140 and the upper face 110A of the case 110, and fixes the rubber stem 140 to the upper face 110A of the case 110.

For example, the cover member 120 is formed by processing a metal plate using a processing method such as press forming. When viewed from above, the cover member 120 has the circular opening 120A at the center thereof in order to allow the operation portion 141 of the rubber stem 140 to protrude upward.

Additionally, each of the left-right sides of the outer peripheral edge of the cover member 120 has the hook 121 downwardly suspended. The hook 121 has the opening 121A into which the claw 111 provided on the side face of the case 110 is fitted. This allows the hook 121 to be hooked onto the claw 111, thereby fixing the cover member 120 to the case 110.

### Detailed Configuration Of Interior Of Accommodation Portion 110B Of Case 110

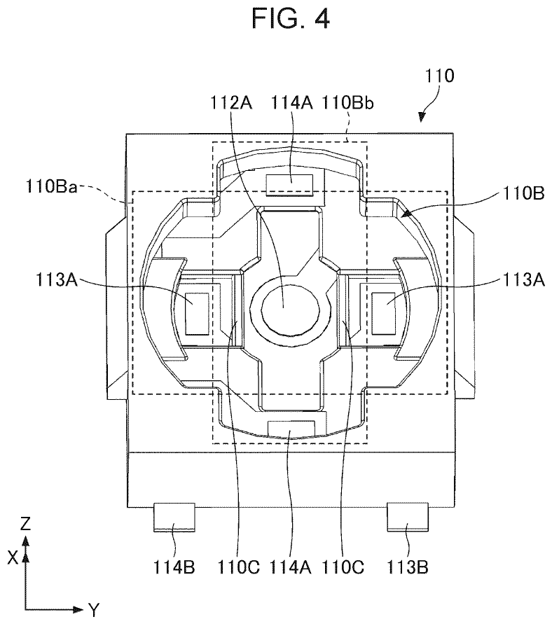

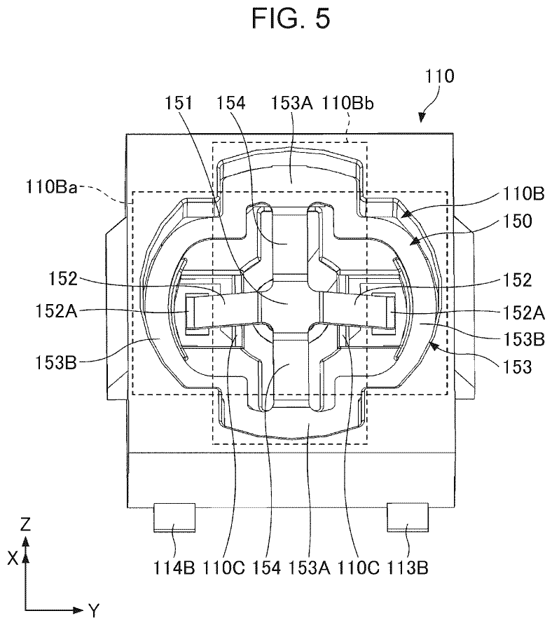

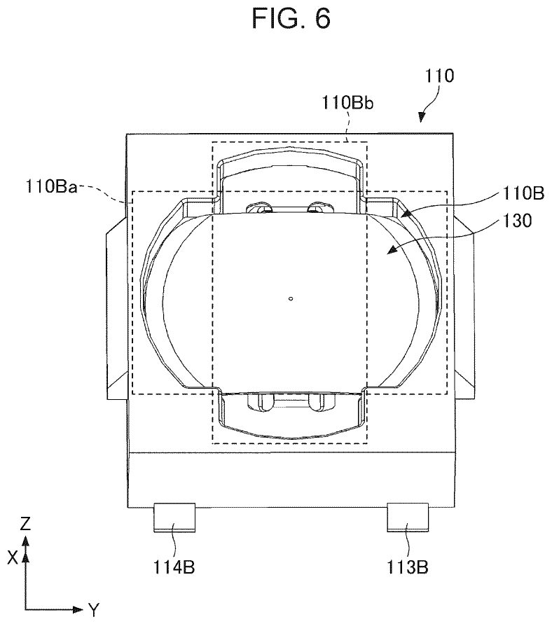

FIG. 4 is an appearance perspective view of the case 110 of the push switch 100 according to an embodiment. FIG. 5 is an appearance perspective view of the case 110 (with the movable contact member 150 disposed) of the push switch 100 according to an embodiment. FIG. 6 is an appearance perspective view of the case 110 (with the movable contact member 150 and the leaf spring member 130 disposed) of the push switch 100 according to an embodiment.

As shown in FIG. 4, the accommodation portion 110B of the case 110 includes a first space 110Ba extending in the left-right direction (Y axis direction) and a second space 110Bb extending in the front-back direction (X axis direction), which intersect to form a cross-shaped configuration in plan view from above (Z axis positive direction).

Furthermore, the central fixed contact 112A is provided at the center portion of the bottom of the accommodation portion 110B of the case 110. Additionally, at the bottom of the accommodation portion 110B (first space 110Ba) of the case 110, the pair of peripheral fixed contacts 113A is disposed side by side in the left-right direction (Y axis direction), with the central fixed contact 112A interposed therebetween. Additionally, at the bottom of the accommodation portion 110B (second space 110Bb) of the case 110, the pair of common contacts 114A is disposed side by side in the front-back direction (X axis direction), with the central fixed contact 112A interposed therebetween.

The pair of peripheral fixed contacts 113A is provided at a position lower than the central fixed contact 112A. Furthermore, the pair of common contacts 114A is provided at a position higher than the central fixed contact 112A.

Furthermore, the face on which the central fixed contact 112A is provided is higher than the face on which the pair of peripheral fixed contacts 113A is provided, and raised portions 110C extending in the front-back direction (X axis direction) with a certain width in the left-right direction are provided at the left and right ends of the face on which the central fixed contact 112A is provided.

As shown in FIG. 5, the flat, metal movable contact member 150 is placed on the bottom of the accommodation portion 110B of the case 110. The movable contact member 150 includes the central movable contact 151, the pair of tongue portions 152, the outer frame portion 153, and a pair of connection portions 154, with these members integrally formed into a single metal plate.

The central movable contact 151 is provided at the center portion of the movable contact member 150 and is disposed facing the center portion of the bottom of the accommodation portion 110B of the case 110. As shown in FIG. 5, when the movable contact member 150 is placed on the bottom of the accommodation portion 110B of the case 110, the central movable contact 151 is disposed upward away from the central fixed contact 112A. Therefore, the movable contact member 150 is not electrically connected to the central fixed contact 112A.

The pair of tongue portions 152 extends from the central movable contact 151 in the left-right direction (Y axis direction) and diagonally downward. Each of the pair of tongue portions 152 has a peripheral movable contact 152A at the distal end portion thereof. As shown in FIG. 5, when the movable contact member 150 is placed on the bottom of the accommodation portion 110B of the case 110, the pair of peripheral movable contacts 152A contacts the pair of peripheral fixed contacts 113A provided at the bottom of the accommodation portion 110B (first space 110Ba) of the case 110. As a result, the movable contact member 150 is electrically connected to each of the pair of peripheral fixed contacts 113A. Specifically, the pair of peripheral movable contacts 152A is pressed against the pair of peripheral fixed contacts 113A by the spring force of the pair of tongue portions 152, thereby achieving stable contact with the pair of peripheral fixed contacts 113A.

Furthermore, each of the pair of tongue portions 152 is cantilever-supported by the central movable contact 151 and is capable of being elastically deformed. Furthermore, each of the pair of tongue portions 152 has an intermediate portion in the left-right direction (Y axis direction) in contact with the raised portion 110C provided at each of the left and right ends of the face where the central fixed contact 112A is provided. As a result, each of the pair of tongue portions 152 is elastically deformed (that is, flipped upward) so that, when the central movable contact 151 is pressed from above (Z axis positive direction), the downward (Z axis negative direction) tilt is eliminated with the raised portion 110C as a pivot, allowing the peripheral movable contact 152A, provided at the distal end portion of the respective tongue portion 152, to be away from the peripheral fixed contact 113A.

The outer frame portion 153 has a frame-like structure that surrounds the central movable contact 151 and the pair of tongue portions 152. The outer frame portion 153 has a shape that follows the inner wall face of the accommodation portion 110B of the case 110. Specifically, in the present embodiment, the outer frame portion 153 has a cross-shaped configuration in plan view from above (Z axis positive direction).

A portion of the outer frame portion 153, the portion protruding forward (X axis positive direction) and backward (X axis negative direction), is a pair of contact portions 153A. The pair of contact portions 153A is placed on the pair of common contacts 114A provided at the bottom of the accommodation portion 110B (second space 110Bb) of the case 110. As a result, the movable contact member 150 is electrically connected to each of the pair of common contacts 114A.

A portion of the outer frame portion 153, the portion protruding left (Y axis negative direction) and right (Y axis positive direction), is a pair of curved placement portions 153B. The pair of placement portions 153B supports the leaf spring member 130 with the curved left and right edges of the leaf spring member 130 placed on the placement portions 153B.

The pair of connection portions 154 extends from the central movable contact 151 in the front-back direction (X axis direction). The pair of connection portions 154 connects the central movable contact 151 to the pair of contact portions 153A of the outer frame portion 153. The pair of connection portions 154 vertically movably supports the central movable contact 151. For example, when the central movable contact 151 is pressed from above (Z axis positive direction), the pair of connection portions 154 can move the central movable contact 151 downward (Z axis negative direction) by being elastically deformed.

As shown in FIG. 6, a metal leaf spring member 130 is disposed above the movable contact member 150 inside the accommodation portion 110B of the case 110. Specifically, the leaf spring member 130 is disposed inside the accommodation portion 110B (first space 110Ba) of the case 110 so that the longitudinal direction of the leaf spring member 130 aligns with the left-right direction (Y axis direction).

At this point, the left and right edges of the movable contact member 150 are placed on the pair of curved placement portions 153B (that is, the metal portions) that the movable contact member 150 has. This prevents the case 110 (that is, the resin portion) from being worn away by the left and right edges of the movable contact member 150 during the inversion motion of the movable contact member 150.

### Operation Of Push Switch 100

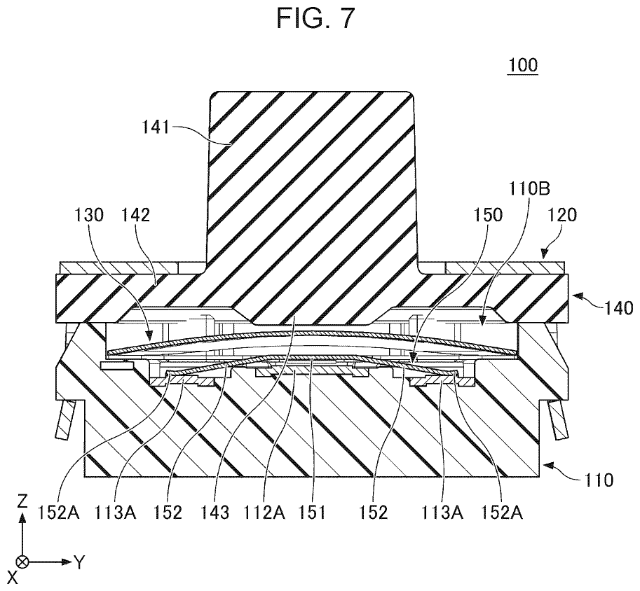

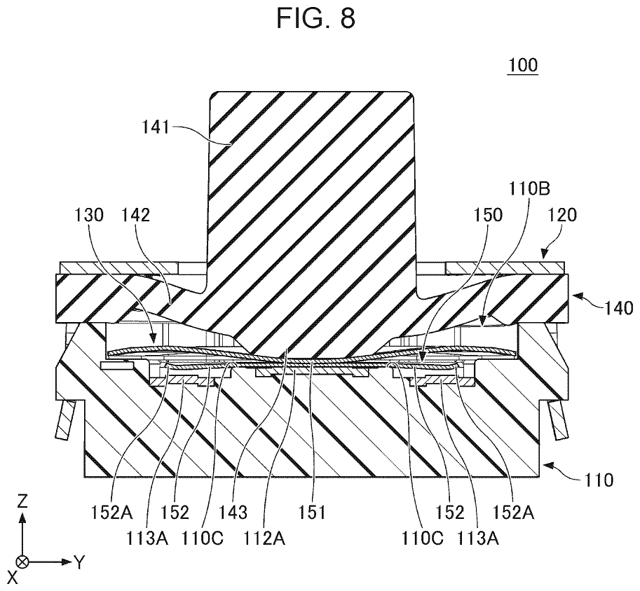

FIG. 7 is a cross-sectional view showing the state of the push switch 100 according to an embodiment at the time of the non-pressing operation. FIG. 8 is a cross-sectional view showing the state of the push switch 100 according to an embodiment at the time of the pressing operation.

As shown in FIG. 7, when no pressing operation is performed by an operator on the operation portion 141 of the rubber stem 140, the push switch 100 according to an embodiment is in an initial state where the base portion 142 of the rubber stem 140 is horizontal, the operation portion 141 and the pressing portion 143 of the rubber stem 140 are at their highest position, and the leaf spring member 130 is upwardly convex. At this time, the movable contact member 150 has the central movable contact 151 away from the central fixed contact 112A, while the pair of contact portions 153A is in contact with the pair of common contacts 114A, and the pair of peripheral movable contacts 152A is in contact with the pair of peripheral fixed contacts 113A. Therefore, when no pressing operation is performed by the operator on the operation portion 141 of the rubber stem 140, the push switch 100 according to an embodiment is in a first switch-on state in which the pair of common contacts 114A and the pair of peripheral fixed contacts 113A are electrically connected with each other via the movable contact member 150.

As shown in FIG. 8, in the push switch 100 according to an embodiment, when the operator performs the pressing operation on the operation portion 141 of the rubber stem 140, the base portion 142 of the rubber stem 140 is elastically deformed, so that the operation portion 141 and the pressing portion 143 of the rubber stem 140 move downward, causing the pressing portion 143 to press down the top (central portion) of the leaf spring member 130. As a result, the leaf spring member 130 undergoes an elastic deformation (inversion motion) into a recessed shape, and the underside of the top (central portion) of the leaf spring member 130 presses the central movable contact 151 of the movable contact member 150. As a result, the central movable contact 151 contacts the central fixed contact 112A.

When the central movable contact 151 is pressed down, each of the pair of tongue portions 152 is flipped up with the raised portion 110C (an example of a “pivot portion”), provided at each of the left and right ends of the face where the central fixed contact 112A is provided, as a pivot. This eliminates the downward tilt (Z axis negative direction) of each of the pair of tongue portions 152, allowing the peripheral movable contact 152A, provided at the distal end portion of the tongue portion 152, to be away from the peripheral fixed contact 113A.

Furthermore, the pair of peripheral movable contacts 152A maintains the state of being in contact with the pair of peripheral fixed contacts 113A. Therefore, when the operator performs the pressing operation on the operation portion 141 of the rubber stem 140, the push switch 100 according to an embodiment is in a second switch-on state in which the pair of common contacts 114A and the central fixed contact 112A are electrically connected with each other via the movable contact member 150.

### Pressing Configuration By Protrusion 145 Of Rubber Stem 140

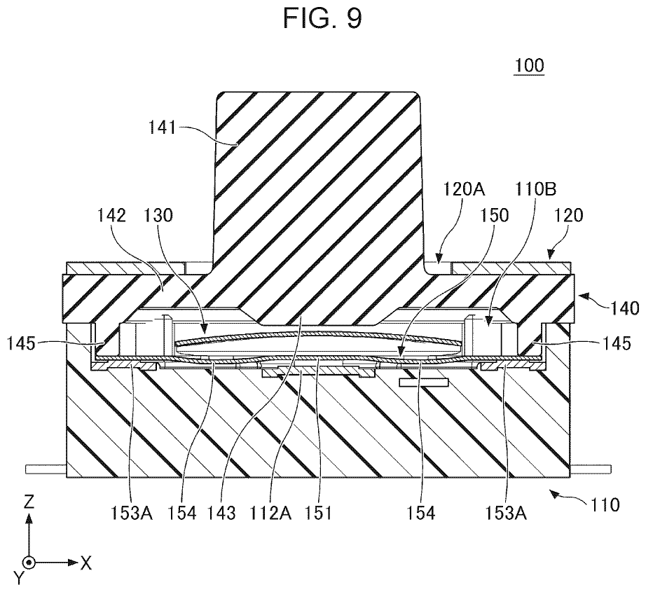

FIG. 9 is a cross-sectional view showing the pressing configuration by a protrusion 145 of the rubber stem 140 of the push switch 100 according to an embodiment.

As shown in FIG. 9, the rubber stem 140 has two protrusions 145 provided left and right. The protrusion 145 is provided extending downward (X axis negative direction) from the bottom face of the base portion 142. The two protrusions 145 press down the pair of contact portions 153A of the movable contact member 150, which is placed on the pair of common contacts 114A, from above (Z axis positive direction).

Accordingly, the push switch 100 according to an embodiment can stably maintain a state (that is, an electrically connected state) in which the pair of contact portions 153A is in contact with the pair of common contacts 114A.

As described above, in the push switch 100 according to an embodiment, the movable contact member 150 includes the pair of tongue portions 152 that extends diagonally downward from the central movable contact 151. When the central movable contact 151 is pressed by the leaf spring member 130, the central movable contact 151 moves downward while the pair of tongue portions 152 is elastically deformed, causing the central movable contact 151 to contact the central fixed contact 112A.

This allows the push switch 100 according to an embodiment to shorten the switching time of the contact state between the central movable contact 151 and the central fixed contact 112A, so that, for example, in a case where the push switch 100 is configured so that a first switch-on state in which the peripheral movable contact 152A and the peripheral fixed contact 113A are electrically connected with each other at the time of the non-pressing operation occurs, and a second switch-on state in which the central movable contact 151 and the central fixed contact 112A are electrically connected with each other at the time of the pressing operation occurs, it is possible to shorten the switching time between the first switch-on state and the second switch-on state. For example, according to the push switch 100 according to an embodiment, the switching time between the first switch-on state and the second switch-on state can be less than 10 ms as required by the ANSI standard.

Specifically, in the push switch 100 according to an embodiment, when the central movable contact 151 is not pressed by the leaf spring member 130, the pair of tongue portions 152 contacts the pair of peripheral fixed contacts 113A, and when the central movable contact 151 is pressed by the leaf spring member 130, the central movable contact 151 contacts the central fixed contact 112A, and the pair of tongue portions 152 is away from the pair of peripheral fixed contacts 113A.

Accordingly, the push switch 100 according to an embodiment can shorten the switching time between the state (that is, the first switch-on state) in which the movable contact member 150 is in contact with the pair of peripheral fixed contacts 113A and the state (that is, the second switch-on state) in which the movable contact member 150 is in contact with the central fixed contact 112A.

Furthermore, in the push switch 100 according to an embodiment, when the central movable contact 151 is pressed by the leaf spring member 130, the central movable contact 151 contacts the central fixed contact 112A, and the downward tilt of the pair of tongue portions 152 is eliminated, causing the pair of tongue portions 152 to be away from the pair of peripheral fixed contacts 113A.

Accordingly, the push switch 100 according to an embodiment can extremely shorten intervals between the timing when the pair of tongue portions 152 is away from the pair of peripheral fixed contacts 113A and the timing when the central movable contact 151 contacts the central fixed contact 112A, since the operation of the central movable contact 151 is interlinked with the operation of the pair of tongue portions 152.

Specifically, in the push switch 100 according to an embodiment, when the central movable contact 151 is pressed by the leaf spring member 130, the downward tilt of the pair of tongue portions 152 is eliminated with the raised portion 110C (pivot portion) provided around the central fixed contact 112A as a pivot.

Accordingly, the push switch 100 according to an embodiment can, with a relatively simple configuration, utilize the pressing force applied to the central movable contact 151 to eliminate the downward tilt of the pair of tongue portions 152.

Furthermore, in the push switch 100 according to an embodiment, when the central movable contact 151 is not pressed by the leaf spring member 130, the pair of tongue portions 152 contact the pair of peripheral fixed contacts 113A, causing the common contact 114A and the pair of peripheral fixed contacts 113A to be electrically connected with each other, and when the central movable contact 151 is pressed by the leaf spring member 130, the central movable contact 151 contacts the central fixed contact 112A, causing the common contact 114A and the central fixed contact 112A to be electrically connected with each other.

This enables the push switch 100 according to an embodiment to shorten the switching time between the state (that is, the first switch-on state) in which the common contact 114A and the pair of peripheral fixed contacts 113A are electrically connected with each other and the state (that is, the second switch-on state) in which the common contact 114A and the central fixed contact 112A are electrically connected with each other.

Furthermore, in the push switch 100 according to an embodiment, when the leaf spring member 130 is pressed from above, the leaf spring member 130 performs an inversion motion and presses the central movable contact 151, causing the central movable contact 151 to contact the central fixed contact 112A.

Accordingly, the push switch 100 according to an embodiment can provide the operator with a click operation feel by the leaf spring member 130 at the same timing as the central movable contact 151 contacts the central fixed contact 112A.

The above description has detailed an embodiment of the present invention. However, the present invention is not limited to the embodiment and may be subject to various modifications or changes within the scope of the essence of the invention as described in the appended claims. For example, in the above embodiment, the movable contact member 150 has the pair of tongue portions 152, but the present invention is not limited thereto. For instance, the movable contact member 150 may have a different number of tongue portions 152 (for example, one, two, four, etc.). Furthermore, the plurality of tongue portions 152 of the movable contact member 150 may have different lengths and widths individually.

1. A push switch comprising:
a case including an accommodation portion;
a central fixed contact provided at a center portion of a bottom of the accommodation portion;
a movable contact member disposed inside the accommodation portion, the movable contact member including:
a central movable contact releasably connected to the central fixed contact; and
at least one tongue portion extending in a direction away from the central movable contact; and
a metal leaf spring member disposed above the movable contact member in the accommodation portion, the metal leaf spring member being configured to press the central movable contact when subjected to a pressing force from above and generate an operation sensation,
wherein when the central movable contact is pressed by the leaf spring member, the central movable contact moves downward while the tongue portion is elastically deformed, thereby causing the central movable contact to contact the central fixed contact.

2. The push switch according to claim 1, wherein the movable contact member includes a pair of the tongue portions extending diagonally downward from the central movable contact.

3. The push switch according to claim 2, further comprising:
a pair of peripheral fixed contacts provided at a periphery of the bottom of the accommodation portion,
wherein when the central movable contact is not pressed by the leaf spring member, the pair of tongue portions are in contact with the pair of peripheral fixed contacts, and
wherein when the central movable contact is pressed by the leaf spring member, the central movable contact contacts the central fixed contact, and the pair of tongue portions are away from the pair of peripheral fixed contacts.

4. The push switch according to claim 3,
wherein when the central movable contact is pressed by the leaf spring member, the central movable contact contacts the central fixed contact, and a downward tilt of the pair of tongue portions is canceled, thereby causing the pair of tongue portions to be away from the pair of peripheral fixed contacts.

5. The push switch according to claim 4,
wherein the movable contact member further includes:
a pivot portion provided around the central fixed contact, and
wherein the downward tilt is canceled by an elastic deformation of the pair of tongue portions around the pivot portion as a pivot.

6. The push switch according to claim 3, further comprising:
a common contact provided at the periphery of the bottom of the accommodation portion,
wherein the movable contact member further includes:
an outer frame portion placed on the common contact,
wherein when the central movable contact is not pressed by the leaf spring member, the pair of tongue portions contact the pair of peripheral fixed contacts, thereby causing the common contact and the pair of peripheral fixed contacts to be electrically connected with each other, and
wherein when the central movable contact is pressed by the leaf spring member, the central movable contact contacts the central fixed contact, thereby causing the common contact and the central fixed contact to be electrically connected with each other.

7. A push switch according to claim 6, wherein when the leaf spring member is pressed from above, the leaf spring member performs an inversion motion and presses the central movable contact, thereby causing the central movable contact to contact the central fixed contact.

8. The push switch according to claim 6, wherein the leaf spring member is placed on the outer frame portion of the movable contact member.

9. The push switch according to claim 2, wherein each of the pair of tongue portions extends in a symmetrical direction diagonally downward from the central fixed contact.
